(19) United States
(12) Patent Application Publication
(10) Pub. No.: US 2021/0221585 A1
(43) Pub. Date: Jul. 22, 2021

(54) FOLDING BAG AND METHOD OF FOLDING FOLDING BAG

(71) Applicant: Shigemitsu Kitamura, Tokyo (JP)

(72) Inventor: Shigemitsu Kitamura, Tokyo (JP)

(21) Appl. No.: 16/314,055

(22) PCT Filed: Dec. 13, 2017
(86) PCT No.: PCT/JP2017/044710

§ 371 Date: Dec. 28, 2018

(30) Foreign Application Priority Data
Dec. 6, 2017 (JP) 2017-234615

(51) Int. Cl. B65D 65/06; B65D 30/00; A45C 7/00; B31B 70/26

(52) U.S. Cl. CPC B65D 65/06; B65D 29/00; B31B 2150/00; B31B 70/26; A45C 7/0059

(57) ABSTRACT

A folding bag which can make the variations of a bag main body multifunctional to make it possible to improve the versatility is provided. A first piece of base fabric and a second piece of base fabric which are foldable and have engagement surfaces which can be engaged with each other such that male-female properties are changed on a front surface side and a rear surface side, and the first piece of base fabric and a second piece of base fabric have the same halved shapes including a center with respect to a predetermined developed shape, joint sides jointed to each other such that a foldable integrated sheet-like object exhibiting a predetermined developed shape in a state in which the engagement surface on the front surface side and the engagement surface on the rear surface side are alternated.

### TECHNICAL FIELD

The present invention relates to a folding bag formed by folding a sheet-like object having a predetermined developed shape and a method of folding a folding bag.

### BACKGROUND ART

A conventional folding bag formed by folding a sheet-like object having a predetermined developed shape is known.

For example, in a known paper bag, after two facing side of a rectangular sheet are bonded to each other, one opening is folded up, and overlapped parts are bonded to each other to obtain a bag.

However, such a paper bag cannot be carried while a predetermined developed shape is arbitrarily folded up, a completed product serving as a paper bag must be folded up, and the paper bag disadvantageously easily becomes voluminous.

In addition, a known piece of wrapping cloth can be easily carried while a predetermined developed shape is folded. However, a stored object jumps out unless facing corner parts are knotted together, and a cumbersome wrapping operation is required. In addition, even though holes for a carrying handle are formed near the four corners, the stored object easily moves, and the wrapping cloth is not adequate to wrap a small object to be wrapped.

On the other hand, a folding bag in which snap buttons are fixed to one sheet material to make it possible that a developing state in which fastening by the snap button is canceled to develop the sheet material and an assembling state in which the sheet material is bent to fix bent parts to each other with the snap buttons can be made changeable is proposed.

### SUMMARY OF THE INVENTION

### Problem to be Solved by the Invention

However, with respect to the conventional folding bag, the shape of a bag main body in the assembling state is limited because the positions of the snap buttons are fixed, and a stored object easily moves in the bag main body as in case of wrapping cloth, and the folding bag is not adequate to store a small object to be stored.

The present invention has an object to provide a folding bag in which one cloth material is folded in bag shapes of a plurality of modes to make it possible that storage objects having various sizes and various shapes can be stored inside of the bag and can be easily carried and a method of folding a folding bag.

### Means for Solving the Problem

In order to achieve the above object, an invention described in claim 1 provides a folding bag including a first piece of base fabric and a second piece of base fabric which are foldable and have engagement surfaces which can be engaged with each other such that male-female properties are changed on a front surface side and a rear surface side, wherein the first piece of base fabric and a second piece of base fabric have the same halved shapes including a center with respect to a predetermined developed shape, joint sides jointed to each other such that a foldable integrated sheet-like object exhibiting a predetermined developed shape in a state in which the engagement surface on the front surface side and the engagement surface on the rear surface side are alternated, and at least one pair of holes facing each other through the center when the joint sides are jointed to each other to form the integrated sheet-like object exhibiting the predetermined developed shape, and, when the integrated sheet-like object exhibiting the predetermined developed shape is folded, the engagement surface on the front surface side and the engagement surface on the rear surface side of the first piece of base fabric or the second piece of base fabric are engaged with each other to form a bag main body having a predetermined three-dimensional shape.

In the another aspect of the present invention, when the integrated sheet-like object having the predetermined developed shape is folded to configure the predetermined three-dimensional bag main body, the holes serve as gripping parts.

In the another aspect of the present invention, the first piece of base fabric and the second piece of base fabric exhibit isosceles triangles and configure an integrated sheet-like object formed such that a predetermined developed shape obtained when long sides between the equal sides are jointed to each other as the joint sides is square, and the holes are formed in, of the four corner parts obtained when the predetermined developed shape is square, corner parts facing each other through a center not crossing the first piece of base fabric and the second piece of base fabric.

In the another aspect of the present invention, the first piece of base fabric and the second piece of base fabric exhibits an isosceles triangle and configure an integrated sheet-like object formed such that a predetermined developed shape obtained when long sides between the equal sides are jointed to each other as the joint sides is square, and the holes are formed in, of the four corner parts obtained when the predetermined developed shape is square, corner parts facing each other through a center crossing the first piece of base fabric and the second piece of base fabric.

In the another aspect of the present invention, the first piece of base fabric and the second piece of base fabric exhibit isosceles triangles and configure an integrated sheet-like object formed such that a predetermined developed shape obtained when long sides between the equal sides are jointed to each other as the joint sides is square, and the holes are formed in the four corner parts when the predetermined developed shape is square.

The present invention provides a folding method using the integrated sheet-like object described in claim 3 or claim 5, including a first folding-back procedure, in a state in which a male-side engagement surface or a female-side engagement surface of the first piece of base fabric and a female-side engagement surface or a male-side engagement surface of the second piece of base fabric are set as one-surface sides, setting one of the corner parts of any one of the first piece of base fabric or the second piece of base fabric as an apex and folding back a left-side region or a right-side region in a width direction to observer's right on the one-surface side or observer's left on the one-surface side, a second folding-back procedure folding back the right-side region or the left-side region in the width direction to the observer's left on the one-surface side or the observer's right on the one-surface side, and a third folding-back procedure folding back the one-surface side of the second piece of base fabric and the first piece of base fabric using the joint side as a valley folding line such that the hole of the first piece of first base fabric and the hole of the second piece of base fabric located at the corner parts not crossing the first piece of base fabric and the second piece of base fabric overlap each other.

The present invention provides a folding method using the integrated sheet-like object described in any one of claim 3 to claim 5, including a first center-folding procedure matching any one of corner parts of the first piece of base fabric or the second piece of base fabric with the other corner part, a second center-folding procedure folding back a bottom-side region facing the corner parts of the overlapping first and second pieces of base fabric while leaving an apex-side region including the corner parts, a fourth center-folding procedure folding back the apex-side region in a strip-shaped body as a whole toward the bottom-side region, and a connecting procedure overlapping both ends such that the entire strip-shaped body becomes strip-shaped.

The present invention provides a folding method using the integrated sheet-like object described in claim 4 or claim 5, including a third center-folding procedure, in a state in which a male-side engagement surface or a female-side engagement surface of the first piece of base fabric and a female-side engagement surface or a male-side engagement surface of the second piece of base fabric are set as one-surface sides, setting one corner part crossing the first piece of base fabric and the second piece of base fabric as an apex and folding back a lower half region including the other corner part and an upper half region including one corner part to observer's upper side or observer's lower side, a fifth folding-back procedure folding back a left-side region or a right-side region in a width direction to a one-surface side or an other-surface side such that an oblique line of the second piece of base fabric or the first piece of base fabric is substantially horizontal and a left-side corner part or a right-side corner part is substantially matched with the oblique line of the second piece of base fabric or the first piece of base fabric, and a sixth folding-back procedure folding back the right-side region or the left-side region in the width direction to a one-surface side or an other-surface side such that the oblique line of the first piece of base fabric or the second piece of base fabric is substantially horizontal and a right-side corner part or a left-side corner part is substantially matched with the oblique line of the second piece of base fabric or the first piece of base fabric.

### Advantageous Effect

According to the present invention, since the front surface side and the rear surface side of each of the first piece of base fabric and the second piece of base fabric serve as different male and female engagement surfaces, regardless of whether the bag main body is the first piece of base fabric or the second piece of base fabric in a folding process and in a final shape of the bag main body, the different female and male engagement surfaces can be planarly engaged with each other.

In this manner, even though the back main body is configured in a state in which an object to be stored is arbitrarily stored in the bag, when engagement surfaces of portions including the periphery of the object to be stored are different female and male surfaces, the object to be stored can be wrapped such that the object is kept at the position. In addition, even though no object to be stored is stored, when the bag is folded, air does not easily enter a space between facing surfaces, and the bag can be made difficult to return to the developed shape. Since the folding shape can be easily maintained, the bag can be made not to be voluminous when the object is stored in another bag or the like.

Thus, the variations of the folded bag main body can be made multifunctional to make it possible to improve the versatility.

When the bag is folded to expose the holes, the holes can be used as a gripping part.

When the first piece of base fabric and the second piece of base fabric are jointed to each other in an isosceles triangle to obtain an integrated sheet-like object such that a predetermined developed shape is a square, even though the bag is used in the mode of a piece of traditional wrapping cloth which is user-friendly, the four corners need not be knotted. In addition, when the positions of the holes are formed at, of the four corner parts, corner parts facing each other through a center not crossing the first piece of base fabric and the second piece of base fabric and, of the four corner parts, corner parts facing each other through a center crossing the first piece of base fabric and the second piece of base fabric, and four corner parts, the bag main body folded in a regulated folding shape using the holes as the gripping part can be easily formed.

Furthermore, the integrated sheet-like object is folded back according to a predetermined procedure, each of the bag main bodies can be easily formed.

The folding bag and the method of folding a folding bag according to the present inventions, the variations of the folded bag main body is made multifunctional to make it possible to improve the versatility.

More specifically, the integrated sheet-like object configured by the foldable first piece of base fabric and the foldable second piece of base fabric having engagement surfaces which can be engaged with each other to have a front surface side and a rear surface side having different male and female shapes is folded by a plurality of folding manners to make it possible to form bags having different modes, and the bag can be used for various purposes. For this reason, the bag is configured by transforming the same integrated sheet-like object in a plurality of modes, can be used for various purposes, and is very convenient.

As a result, since a pocket part is formed in the bag main body formed by folding, storage objects having various predetermined sizes and shapes are stored in the pocket part in a stable state and can be easily carried.

In addition, although the integrated sheet-like object has a shape similar to an ordinary piece of wrapping cloth, the integrated sheet-like object is folded to form a pocket part to make it possible to reliably store a storage object therein. The integrated sheet-like object is easily changed in the shape of a bag or the like which can be carried by gripping gripping parts and can be used.

Furthermore, unlike in a case in which a plurality of snap buttons are disposed on a conventional sheet material and the snap buttons are alternately engaged with each other to maintain a folding state and to form a bag shape, snap buttons need not be fixed to a cloth material. For this reason, a folding bag which can reduce manufacturing costs and the number of manufacturing steps can be provided.

In particular, in the bag formed by the method of folding a folding bag according to the present invention, the bag is folded in a state in which a small storage object is stored and in a state in which the storage object is not store to form an entire strip shape, and the bag can be loaded by being winded on the waist of a user as a belt bag. As a result, the folding bag which can make both the hands of the user and cause the user to freely act can be provided.

### BRIEF DESCRIPTION OF THE DRAWINGS

FIGS. 1A and 1B show a folding bag according to an embodiment of the present invention in which FIG. 1A is a front view of an integrated sheet-like object when a predetermined developed shape is a square and FIG. 1B is a front view of an example of a bag main body.

FIGS. 2A and 2B show the folding bag according to an embodiment of the present invention and are explanatory diagrams of a folding method time-serially showing a folding example starting from the state of a developed shape in FIG. 1A to formation of the bag main body in FIG. 1B.

FIG. 3 shows the folding bag according to an embodiment of the present invention and is an explanatory diagram time-serially showing a folding example starting from the state of the developed shape in FIG. 1A to formation of pouch-shaped bag main body.

FIGS. 4A and 4B show a folding bag according to an embodiment of the present invention in which FIG. 4A is a front view of an integrated sheet-like object when a predetermined developed shape is a square and FIG. 4B is a front view of another example of the bag main body.

FIG. 5 shows a folding bag according an an embodiment of the present invention and is an explanatory diagram of a folding method time-serially showing a folding example starting from the state of the developed shape in FIG. 4A to formation of the bag main body in FIG. 4B.

FIG. 6 shows a folding bag according to an embodiment of the present invention and is a front view of an integrated sheet object when holes are formed in four corner parts when the predetermined developed shape is square.

FIG. 7 shows a folding bag according to an embodiment of the present invention and is a front view of an integrated sheet-like object when four corner parts are rounded when the predetermined developed shape is square.

FIG. 8 shows a folding bag according to an embodiment of the present invention and is a front view of an integrated sheet-like object when a predetermined developed shape is a perfect circle.

### DETAILED DESCRIPTION OF THE INVENTION

An embodiment of the present invention will be described below with reference to the accompanying drawings. In the following explanation, although directions such as vertical directions and horizontal directions are explained with reference to the illustrations, the directions are directions for descriptive convenience, and do not limit the present invention.

In the following explanation, a front surface side and a rear surface side are not limited because a so-called reversible mode is set. Unless otherwise noted, the front surface side serving as base fabric is called a “male side”, and a rear surface side serving as base fabric is also called a “female side”. With reference to a planar side (front surface side) on the illustration when a predetermined developed shape is established, one surface located on the planar side is called a “one-surface side”, and the other surface on the opposite side is also called an “other-surface side”.

### First Embodiment

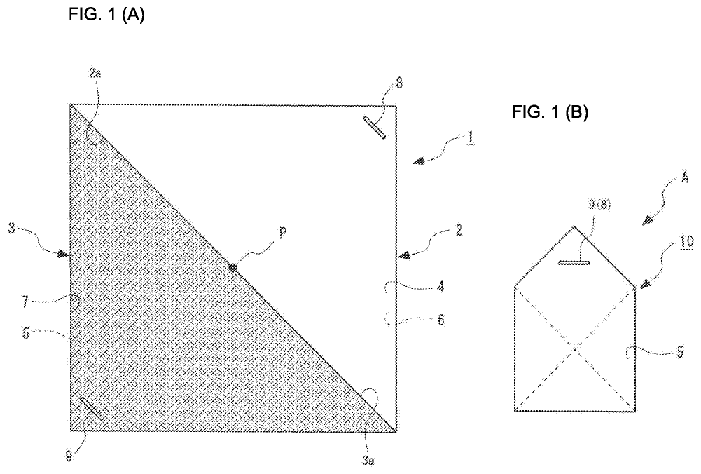

As shown in FIG. 1A, an integrated sheet-like object 1 includes one pair of first piece of base fabric 2 and second piece of base fabric 3 each having an isosceles triangle, and a predetermined developed shape exhibits a square.

As shown in FIG. 1, the first piece of base fabric 2 and the second piece of base fabric 3 have male-side engagement surfaces 4 and 5 and female-side engagement surfaces 6 and 7 which can be engaged with each other such that the front-surface side and the rear-surface side have different male and female properties.

As the male-side engagement surfaces 4 and 5, for example, polyester napped fabric can be used. In addition, as the female-side engagement surfaces 6 and 7, for example, pile fabric made of polyester nano-fiber can be used.

In this manner, since the fabrics have different properties, when the engagement surfaces are engaged with each other, high engagement force can be obtained. Furthermore, good feeling and good drape can be obtained, and the first piece of base fabric 2 and the second piece of base fabric 3 made of thin fabric which can be easily transformed can be obtained.

Thus, the first piece of base fabric 2 and the second piece of base fabric 3 configure front and rear surfaces, i.e., the male-side engagement surface 4 and 5 and the female-side engagement surface 6 and 7 by overlapping two sheets of fabric are overlapped.

The integrated sheet-like object 1 is a joined body obtained such that the first piece of base fabric 2 and the second piece of base fabric 3 have the same halved shapes including a center P with respect to a predetermined developed shape which is square.

In this case, the first piece of base fabric 2 and the second piece of base fabric 3 include joint sides 2a and 3a which are jointed to each other to obtain a foldable integrated sheet-like object 1 exhibiting a predetermined developed shape in a state in which the male-side engagement surfaces 4 and 5 and the female-side engagement surfaces 6 and 7 are alternated and at least one pair of holes 8 and 9 facing each other through the center P when the joint sides 2a and 3a are jointed to form the integrated sheet-like object 1 exhibiting the predetermined developed shape.

The joint sides 2a and 3a, in the embodiment, are long sides sandwiched by the equal sides of the first piece of base fabric 2 and the second piece of base fabric 3 exhibiting isosceles triangles, respectively. The joint sides 2a and 3a, for example, may be jointed to each other by stitching or bonding or may be jointed to each other by using patches or the like.

The holes 8 and 9 are formed in the forms of slits having the same narrow-long rectangular shapes at the same positions of corners, of the four corners, facing each other through the center P not crossing the first piece of base fabric 2 and the second piece of base fabric 3.

As shown in FIG. 1B, a folding bag A serving as an example can form a three-dimensional bag main body 10 formed by folding the integrated sheet-like object 1 in a predetermined order.

As a concrete mode of the folding bag A using the integrated sheet-like object 1 having the above basic configuration, a folding procedure forming the bag main body 10 will be described below.

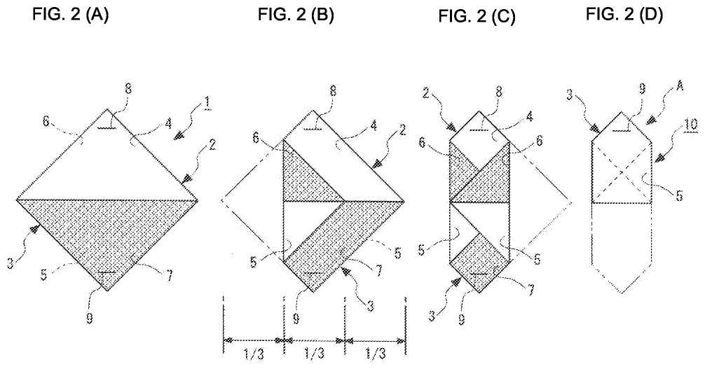

As shown in FIG. 2A, in the integrated sheet-like object 1 having a predetermined developed shape which is square, the male-side engagement surface 4 of the first piece of base fabric 2 and the female-side engagement surface 7 of the second piece of base fabric 3 are set as one-surface sides, as shown in FIG. 2B, a left-side region or right-side region which is about ⅓ in the width direction is folded back to observer's one-surface right side (or one-surface left side) by using the first piece of base fabric 2 or the second piece of base fabric 3 as an apex. This constitutes the first folding-back procedure.

In this manner, the other-surface side of a left-side region or a right-side region which is about ⅓ of the folded original in the width direction is inverted on a one-surface side, and a one-surface side of the left-side region or the right-side region which is about ⅓ of the folded original in the width direction partially overlaps a central region which is about ⅓ in the width direction.

Thus, a part of the female-side engagement surface 6 of the first piece of base fabric 2 located on the other-surface side of the left-side region or the right-side region which is about ⅓ of the inverted original in the width direction is exposed on the one-surface side, and, at the same time, a part of the male-side engagement surface 5 of the second piece of base fabric 3 located on the other-surface side of the left-side region or the right-side region which is about ⅓ of the inverted original in the width direction.

As shown in FIG. 2C, by using the first piece of base fabric 2 or the second piece of base fabric 3 as an apex, the right-side region or the left-side region which is about ⅓ in the width direction is folded back on observer's one-surface left side or one-surface right side. This constitutes the second folding-back procedure.

In this manner, the other-surface side of the right-side region (or the left-side region) which is about ⅓ of the folded original in the width direction is inverted on the one-surface side, and the one-surface side of the right-side region (left-side region) which is about ⅓ of the folded original in the width direction overlaps a part of the left-side region or the right-side region which is ⅓ of the folded original and a part of a central region which is about ⅓ in the width direction.

Thus, a part of the female-side engagement surface 6 of the first piece of base fabric 2 located on the other-surface side of the right-side region or the left-side region which is about ⅓ of the inverted original in the width direction is exposed on the one-surface side, and, at the same time, a part of the male-side engagement surface 5 of the second piece of base fabric 3 located on the other-surface side of the right-side region or the left-side region which is about ⅓ of the inverted original in the width direction is exposed on the one-surface side.

Here, a part of the female-side engagement surface 6 of the first piece of base fabric 2 located on the other-surface side of the left-side region or the right-side region which is about ⅓ of the inverted original in the width direction and a part of the male-side engagement surface 4 of the first piece of base fabric 2 located on the one-surface side of the right-side region or the left-side region which is about ⅓ of the inverted original overlap each other to make an engagement by the characteristics obtained by the difference between the fabrics.

Similarly, a part of the male-side engagement surface 5 of the second piece of base fabric 3 located on the other-surface side of the left-side region or the right-side region which is about ⅓ of the inverted original in the width direction and a part of the female-side engagement surface 7 of the second piece of base fabric 3 located on the one-surface side of the right-side region or the left-side region which is about ⅓ of the inverted original overlap with each other to make an engagement by the characteristics obtained by the difference between the fabrics.

As shown in FIG. 2D, the one-surface side the second piece of base fabric 3 or the first piece of base fabric 2 is folded back by using the joint sides 2a and 3a as valley fold lines such that the hole 8 of the first piece of base fabric 2 and the hole 9 of the second piece of base fabric 3 overlap. This constitutes the third folding-back procedure.

In this manner, the other-surface side of the second piece of base fabric 3 or the first piece of base fabric 2 which is folded and original is inverted on the one-surface side, and the one-surface side of the second piece of base fabric 3 or the first piece of base fabric 2 which is folded and original overlaps the one-surface side of the first piece of base fabric 2 or the second piece of base fabric 3 which is folded and original.

Thus, the male-side engagement surface 5 or the female-side engagement surface 6 of the second piece of base fabric 3 or the first piece of base fabric 2 located on the other-surface side of the second piece of base fabric 3 or the first piece of base fabric 2 which is inverted and original is exposed on the one-surface side.

Here, the male-side engagement surface 5 and the female-side engagement surface 7 located on one-surface side of the second piece of base fabric 3 which is inverted and original and the female-side engagement surface 6 and the male-side engagement surface 4 located on the one-surface side of the original first pieces of base fabric 2 overlap each other to make an engagement by the characteristics obtained by the difference between the fabrics.

In this manner, in the bag main body 10 formed by folding, the holes 8 and 9 can be used as gripping parts, and the left, right, and lower sides are closed to make it possible to form pockets PK which can be opened/closed upward on the first piece of base fabric 2 and the second piece of base fabric 3, respectively.

For example, a purse or the like can be stored in one pocket PK as an object to be stored, and a smart phone or the like can be stored in the other pocket PK as an object to be stored.

In this case, in each of the pockets PK, overlapping parts are planarly engaged with each other by the characteristics obtained by the difference between the fabrics. For this reason, depending on the sizes of objects to be stored, the pieces of base fabric are engaged with each other to surround the periphery of the object to be stored, and the object to be stored can be stably stored.

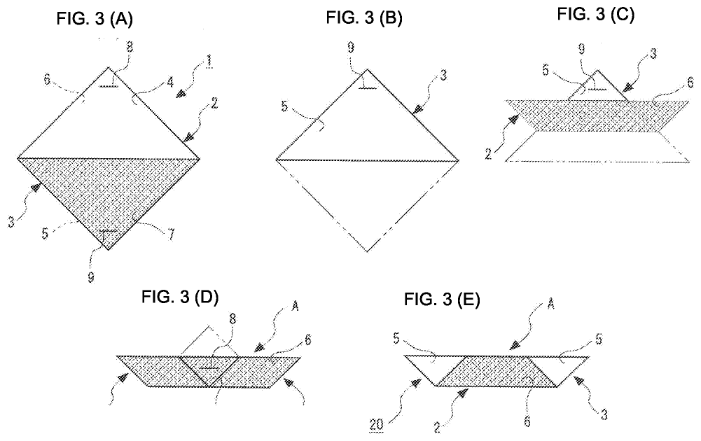

Meanwhile, the folding bag A serving as an example of the embodiment, for example, is subjected to the folding procedure shown in FIG. 3 to form a belt-like bag main body 20 exhibiting a three-dimensional shape, and the bag can also be used as a pouch.

As shown in FIG. 3A, the integrated sheet-like object 1 having a predetermined developed shape which is square is folded back such that the male-side engagement surface 4 of the first piece of base fabric 2 and the female-side engagement surface 7 of the second piece of base fabric 3 are set on the one-surface side, by using the first piece of base fabric 2 or the second piece of base fabric 3 as an apex, as shown in FIG. 3B, the second piece of base fabric 3 faces upward or the first piece of base fabric 2 faces downward, i.e., the first piece of base fabric 2 and the second piece of base fabric 3 overlap each other. This constitutes the first center-folding procedure.

In this manner, the other-surface side of the second piece of base fabric 3 which is folded and original is inverted on the one-surface side, and the male-side engagement surface 4 of the first piece of base fabric 2 which is folded and original and the female-side engagement surface 7 of the second piece of base fabric 3 overlap each other.

In this case, an object to be stored which need not be frequently put in or pulled out, for example, a passport or the like may be stored between the male-side engagement surface 4 of the first piece of base fabric 2 and the female-side engagement surface 7 of the second piece of base fabric 3.

As shown in FIG. 3C, the lower sides of the first piece of base fabric 2 and the second piece of base fabric 3 overlapping each other, for example, a bottom-side region which is about ⅓ of the piece of fabric, is folded back upward to leave a predetermined region which is apex-side region including a corner part. This constitutes the second center-folding procedure. Furthermore, as shown in FIG. 3D, the upper sides, for example, about ⅓ of the second piece of base fabric 3 overlapping each other are folded back downward. This constitutes the fourth folding-back procedure. The fourth folding-back procedure forms a belt-like bag main body which is belt-like body 20 as a whole.

In this case, an object to be stored can be put in or pulled out in a state before the upper sides shown in FIG. 3C are folded back, and the male-side engagement surface 5 of the second piece of base fabric 3 and the female-side engagement surface 6 of the first piece of base fabric 2 are engaged with each other. For this reason, the object to be stored can be protcted from being unexpectedly jumped out.

On the other hand, all the one-surface sides obtained when the belt-like bag main body 20 shown in FIG. 3D is formed are the female-side engagement surface 6 of the first piece of base fabric 2. In contrast to this, on the other-surface side shown in FIG. 3E, the male-side engagement surface 5 of the second piece of base fabric 3 is exposed to both the ends.

Thus, when both the ends of the bag main body 20 are overlapped with each other to form a belt-like shape, as a pouch winded on the waist of a user, the female-side engagement surface 6 on the one-surface side and the male-side engagement surface 5 on the other-surface side overlap each other and engaged with each other to make it possible to maintain a pouch shape.

### Second Embodiment

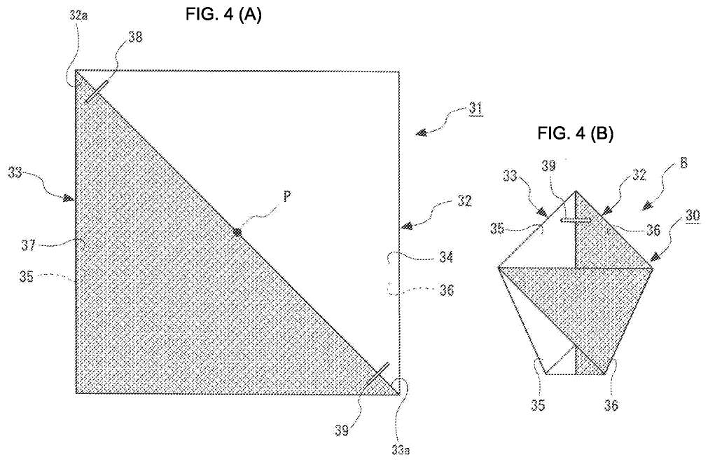

As shown in FIG. 4A, an integrated sheet-like object 31 includes one pair of first piece of base fabric 32 and second piece of base fabric 33 having an isosceles-triangular shape, and a predetermined developed shape exhibits a square.

As shown in FIG. 4, the first piece of base fabric 32 and the second piece of base fabric 33 have male-side engagement surfaces 34 and 35 and female-side engagement surfaces 36 and 37 which can be engaged with each other such that the front-surface side and the rear-surface side have different male and female properties.

As the male-side engagement surfaces 34 and 35, for example, polyester napped fabric can be used. In addition, as the female-side engagement surfaces 36 and 37, for example, pile fabric made of polyester nano-fiber can be used.

In this manner, since the fabrics have different properties, when the engagement surfaces are engaged with each other, although high engagement force can be obtained, and good feeling and good drape can be obtained. Furthermore, the first piece of base fabric 32 and the second piece of base fabric 33 made of thin fabric which can be easily transformed can be obtained.

Thus, the first piece of base fabric 32 and the second piece of base fabric 33 configure front and rear surfaces, i.e., the male-side engagement surface 34 and 35 and the female-side engagement surface 36 and 37 by overlapping two sheets of fabric.

The integrated sheet-like object 31 is a joined body obtained such that the first piece of base fabric 32 and the second piece of base fabric 33 have the same halved shapes including a center P with respect to a predetermined developed shape which is square.

In this case, the first piece of base fabric 32 and the second piece of base fabric 33 include joint sides 32a and 33a which are jointed to each other to obtain a foldable integrated sheet-like object 31 exhibiting a predetermined developed shape in a state in which the male-side engagement surfaces 34 and 35 and the female-side engagement surfaces 36 and 37 are alternated and at least one pair of holes 38 and 39 facing each other through the center P when the joint sides 32a and 33a are jointed to form the integrated sheet-like object 31 exhibiting the predetermined developed shape.

The joint sides 32a and 33a, in the embodiment, are long sides sandwiched by the equal sides of the first piece of base fabric 32 and the second piece of base fabric 33 exhibiting isosceles triangles, respectively. The joint sides 32a and 33a, for example, may be jointed to each other by stitching or bonding or may be jointed to each other by using patches or the like.

The holes 38 and 39 are formed in the forms of slits having the same narrow-long rectangular shapes at the same positions of corners, of the four corners obtained when the predetermined developed shape is square, facing each other through the center P crossing the second piece of base fabric 32 and 33.

As shown in FIG. 4B, a folding bag B serving as an embodiment can form a three-dimensional bag main body 30 formed by folding the integrated sheet-like object 31 in a predetermined order.

As a embodiment of the folding bag B using the integrated sheet-like object 31 having the above basic configuration, a folding procedure forming the bag main body 30 will be described below.

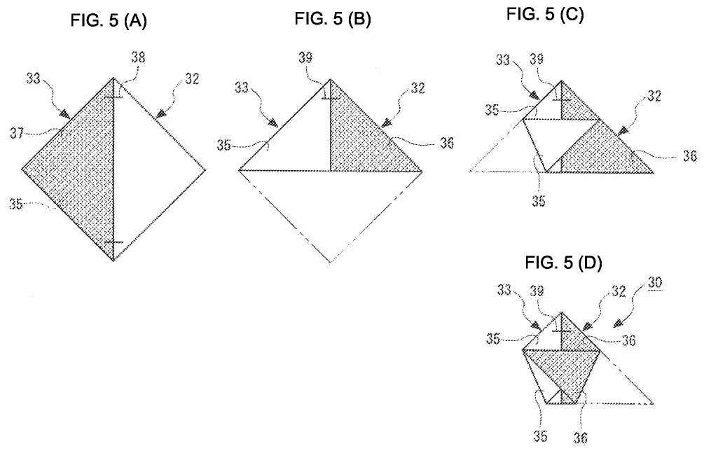

As shown in FIG. 5A, in the integrated sheet-like object 31 having a predetermined developed shape which is square, the male-side engagement surface 34 of the first piece of base fabric 32 and the female-side engagement surface 37 of the second piece of base fabric 33 are set as one-surface sides, as shown in FIG. 5B, a lower-side region or upper-side region is folded back to observer's upper-surface side or lower-surface side by using one corner part crossing the first piece of base fabric 32 and the second piece of base fabric 33 as an apex. This constitutes the third center folding procedure.

In this manner, the other-surface side of a lower-side region or an upper-side region of the folded original is inverted on a one-surface side, and a one-surface side of the lower-side region or the upper-side region of the folded original overlaps the one-surface side of the upper-side region or the lower-side region.

Note that the overlapping surfaces are not engaged with each other because the surfaces have the same male-female properties. The one-surface side and the other-surface side in the state shown in FIG. 5B are the female-side engagement surface 36 of the first piece of base fabric 32 and the male-side engagement surface 35 of the second piece of base fabric 33.

As shown in FIG. 5C, the left-side region or the right-side region in the width direction is folded back on the one-surface side or the other-surface side such that an oblique line of the second piece of base fabric 33 or the first piece of base fabric 32 is substantially horizontal and a left-side corner part or a right-side corner part is substantially matched with the oblique line of the first piece of base fabric 32 or the second piece of base fabric 33. This constitutes the fifth folding-back procedure.

In this manner, the other-surface side of the left-side region (or the right-surface region) of the folded original in the width direction is inverted on the one-surface side, and the one-surface side of the left-side region or the right-side region of the folded original in the width direction overlaps a part of the central region of the folded original.

Thus, a part of the male-side engagement surface 35 of the second piece of base fabric 33 located on the other-surface side of the left-side region or the right-side region of the inverted original in the width direction is exposed on the one-surface side.

Here, a part of the male-side engagement surface 35 of the second piece of base fabric 33 located on the one-surface side of the left-side region or the right-side region of the inverted original in the width direction and a part of the female-side engagement surface 36 of the first piece of base fabric 32 located on the one-surface side of the right-side region or the left-side region of the inverted original overlap with each other to make an engagement by the characteristics obtained by the difference between the fabrics.

As shown in FIG. 5D, the right-side region or the left-side region in the width direction is folded back on the one-surface side or the other-surface side such that an oblique line of the first piece of base fabric 32 or the second piece of base fabric 33 is substantially horizontal and a right-side corner part or a left-side corner part is substantially matched with the oblique line of the second piece of base fabric 33 or the first piece of base fabric 32). This constitutes the sixth folding-back procedure.

In this manner, the other-surface side or the one-surface side of the right-side region or the left-surface region of the folded original in the width direction is inverted on the one-surface side or the other-surface side, and the one-surface side or the other-surface side of the right-side region or the left-side region of the folded original in the width direction overlaps the central region of the folded original and a part of the other-surface side of the left-side region or the right-side region of the inverted original in the width direction.

Thus, a part of the female-side engagement surface 36 of the first piece of base fabric 32 located on the other-surface side or the one-surface side of the right-side region or the left-side region of the inverted original in the width direction is exposed on the one-surface side or the other-surface side.

Here, a part of the female-side engagement surface 36 of the first piece of base fabric 32 located on the one-surface side of the right-side region (or the left-side region) of the inverted original in the width direction and a part of the male-side engagement surface 35 of the second piece of base fabric 33 located on the one-surface side of the left-side region or the right-side region of the inverted original overlap each other to make an engagement by the characteristics obtained by the difference between the fabrics.

Note that, when the right-side region in the width direction is folded back on the other-surface side such that the oblique line of the first piece of base fabric 32 is substantially horizontal and the right-side corner part is substantially matched with the oblique line of the second piece of base fabric 33, a part of the male-side engagement surface 35 of the second piece of base fabric 33 located on the other-surface side of the right-side region of the inverted original in the width direction and a part of the female-side engagement surface 36 of the first piece of base fabric 32 located on the other-surface side of the right-side region of the inverted original overlap each other to make an engagement by the characteristics obtained by the difference between the fabrics.

In the bag main body 30 formed by being folded as described above, the holes 38 and 39 can be used as gripping parts, and the left, right, and lower sides are closed to make it possible to form pockets PK which can be opened/closed on the first piece of base fabric 32 and the second piece of base fabric 33, respectively. At the same time, a pocket PK can be formed between the first piece of base fabric 32 and the second piece of base fabric 33.

In this case, in each of the pocket PK, since the overlapping parts are planarly engaged with each other by the characteristics obtained by the difference between the fabrics, depending on the sizes of object to be stored, the parts are engaged with each other to wind the periphery of the object to be stored to make it possible to store the object to be stored.

Meanwhile, the folding bag B serving as an example of the embodiment, for example, is subjected to the folding procedure shown in FIG. 3 to form a belt-like bag main body 20, and the bag can also be used as a pouch.

### Third Embodiment

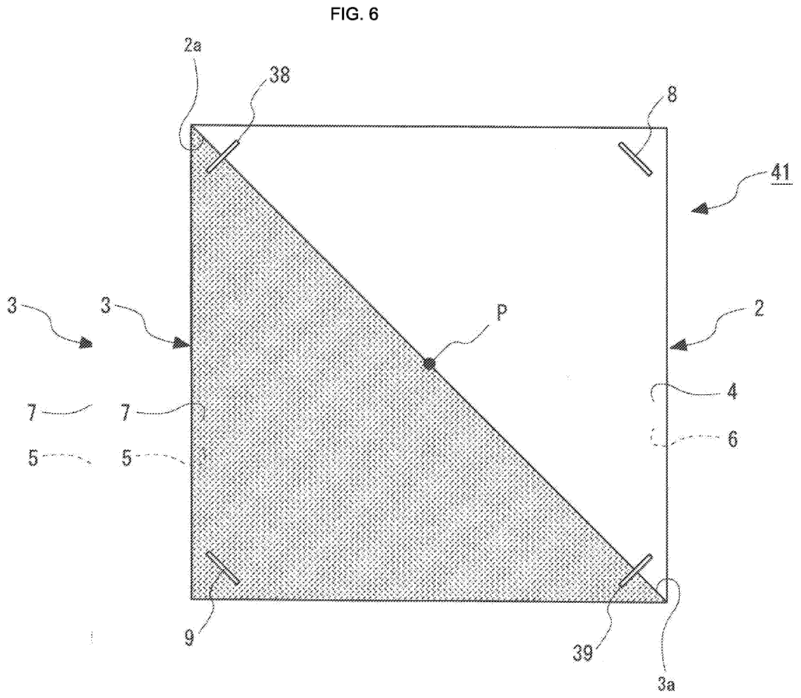

In each of the embodiments, the integrated sheet-like object 1 or 31 when the holes 8 and 9 or the holes 38 and 39 are formed one pair of corner parts, of the fourth corner parts, facing through the center P is shown. However, for example, as shown in FIG. 6, when a sheet-like object 41 in which the holes 8 and 9 and the holes 38 and 39 are formed in all the four corner parts is formed, the sheet-like object 41 can be applied as the bag main body 10, 20, and 30 of all the modes described in the first embodiment and the second embodiment.

According to the present invention, since the front-surface sides and the rear-surface sides of the first piece of base fabric 2 and the second piece of base fabric 3 are the male-side engagement surfaces 4 and 5 and the female-side engagement surfaces 6 and 7 having different female-male properties, regardless of whether the bag main body 10 is the first piece of base fabric 2 or the second piece of base fabric 3 in a folding process and in a final shape of the bag main body 10, the male-side engagement surfaces 4 and 5 and the female-side engagement surfaces 6 and 7 having different female-male properties can be planarly engaged with each other.

In this manner, even though the bag main body 10 is configured in a state in which an object to be stored is arbitrarily stored, when the male-side engagement surfaces 4 and 5 and the female-side engagement surfaces 6 and 7 at a position including the periphery of the object to be stored have different female-male properties, the bag can wrap the object to be stored such that the object remains at the position. In addition, even though no object to be stored is stored, when the bag is folded, air does not easily enter a space between facing surfaces, and the bag can be made difficult to return to the developed shape. Since the folding shape can be easily maintained, the bag can be made not to be voluminous when the object is stored in another bag or the like.

Thus, the variations of the folded bag main body 10 can be made multifunctional to make it possible to improve the versatility.

In addition, the holes 8 and 9 can be used as gripping parts such that the bag main body is folded to expose the holes 8 and 9.

When the first piece of base fabric 2 and the second piece of base fabric 3 are jointed to each other as an isosceles triangle such that the integrated sheet-like object 1 having the predetermined developed shape which is square, even though the bag is used in the mode of a piece of traditional wrapping cloth which is user-friendly, the four corners need not be knotted.

Furthermore, when the holes 8 and 9 are formed at the positions of the corner parts, of the four corner parts, facing each other through the center P not crossing the first piece of base fabric 2 and the second piece of base fabric 3, the bag main body 10 folded in a regulated folded shape using the holes 8 and 9 as gripping parts can be easily formed.

Similarly, when the holes 38 and 39 are formed at the positions of the corner parts, of the four corner parts, facing each other through the center P crossing the first piece of base fabric 2 and the second piece of base fabric 3, the bag main body 30 folded in a regulated folded shape using the holes 8 and 9 as gripping parts can be easily formed.

In addition, when the holes 8 and 9 and the holes 28 and 29 are formed at positions of the four corners, the bag main bodies 10 and 30 folded in regulated folded shapes using the holes 8 and 9 and the holes 28 and 29 as gripping parts can be easily formed.

### Another Embodiment

In addition to the above description, arbitrary combinations of the methods according to the embodiments may be used.

More specifically, in the above embodiments, a configuration in which the first piece of base fabric 2 and the second piece of base fabric 3 exhibit isosceles triangles and the integrated sheet-like object 1 formed such that a predetermined developed shape obtained by jointing long sides sandwiched by the equal sides as the joint sides 2a and 3a is square is illustrated. However, the predetermined developed shape is not limited to the square.

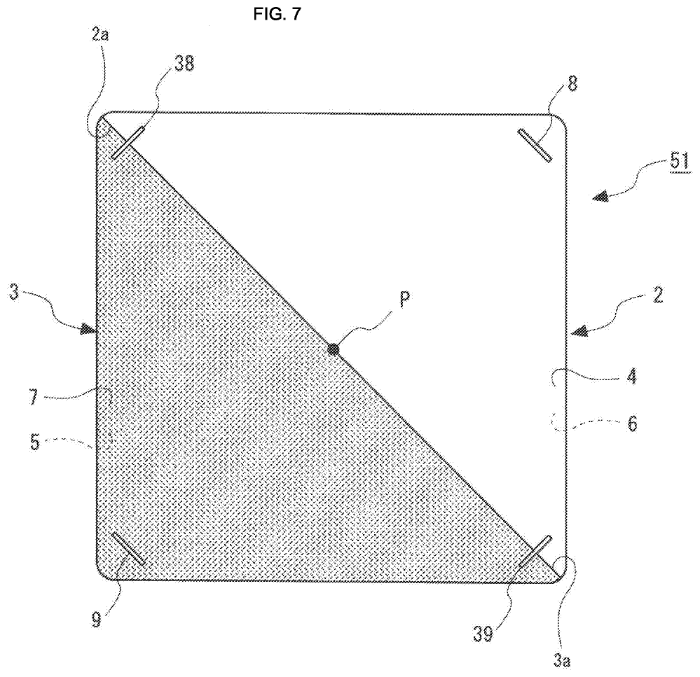

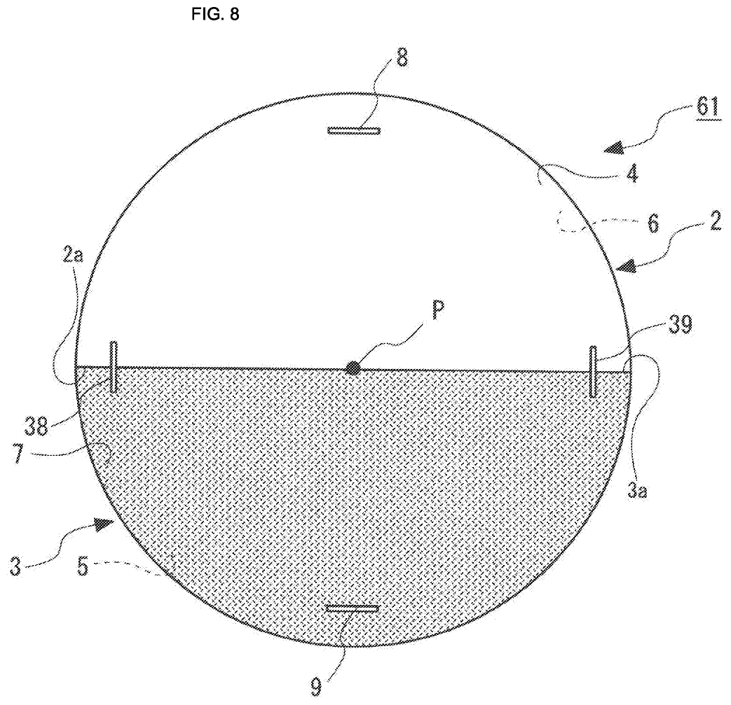

For example, the predetermined developed shape, as shown in FIG. 7, is not limited to a specific shape as long as the shape is a substantially square integrated sheet-like object 51 having four rounded corners, as shown in FIG. 8, a perfect-circular integrated sheet-like object 61, or a joined object including the first piece of base fabric 2 and the second piece of base fabric 3 having the same halved shape such as a regular polygon or rectangle (not shown).

In addition, various changes of the present invention are carried out without departing from the spirit and scope of the invention. The number of a given procedure described above indicates a difference from another procedure, and the numbers of the procedures do not mean relationships between the three procedures described in the embodiments. Similarly, with respect to the procedures in the embodiments, for example, the first folding-back procedure and the second folding-back procedure shown in the first embodiment or the fifth folding-back procedure and the sixth folding-back procedure shown in the second embodiment may be reversed.

As described above, the folding bag and the method of folding the folding bag according to the present invention can advantageously make the variations of the bag main body multifunctional and improve the versatility, and are generally useful to folding bags formed by folding sheet-like objects exhibiting predetermined developed shapes.

1. A folding bag comprising:
a first piece of base fabric and a second piece of base fabric which are foldable and have engagement surfaces which can be engaged with each other such that male-female properties are changed on a front surface side and a rear surface side, wherein
the first piece of base fabric and a second piece of base fabric have the same halved shapes including a center with respect to a predetermined developed shape,
joint sides jointed to each other such that a foldable integrated sheet-like object exhibiting a predetermined developed shape in a state in which the engagement surface on the front surface side and the engagement surface on the rear surface side are alternated, and
at least one pair of holes facing each other through the center when the joint sides are jointed to each other to form the integrated sheet-like object exhibiting the predetermined developed shape, and,
when the integrated sheet-like object exhibiting the predetermined developed shape is folded, the engagement surface on the front surface side and the engagement surface on the rear surface side of the first piece of base fabric or the second piece of base fabric are engaged with each other to form a bag main body having a predetermined three-dimensional shape.

2. The folding bag according to claim 1, wherein
when the integrated sheet-like object having the predetermined developed shape is folded to configure the predetermined three-dimensional bag main body, the holes serve as gripping parts.

3. The folding bag according to claim 1, wherein
the first piece of base fabric and the second piece of base fabric
exhibits an isosceles triangle and configure an integrated sheet-like object formed such that a predetermined developed shape obtained when long sides between the equal sides are jointed to each other as the joint sides is square, and
the holes are formed in, of the four corner parts obtained when the predetermined developed shape is square, corner parts facing each other through a center not crossing the first piece of base fabric and the second piece of base fabric.

4. The folding bag according to claim 1, wherein
the first piece of base fabric and the second piece of base fabric
exhibit isosceles triangles and configure an integrated sheet-like object formed such that a predetermined developed shape obtained when long sides between the equal sides are jointed to each other as the joint sides is square, and
the holes are formed in, of the four corner parts obtained when the predetermined developed shape is square, corner parts facing each other through a center crossing the first piece of base fabric and the second piece of base fabric.

5. The folding bag according to claim 1, wherein
the first piece of base fabric and the second piece of base fabric exhibit isosceles triangles and configure an integrated sheet-like object formed such that a predetermined developed shape obtained when long sides between the equal sides are jointed to each other as the joint sides is square, and the holes are formed in the four corner parts when the predetermined developed shape is square.

6. A method of folding a folding bag using the integrated sheet-like object described in claim 3, comprising the steps of:
a first folding-back procedure, in a state in which a male-side engagement surface or a female-side engagement surface of the first piece of base fabric and a female-side engagement surface or a male-side engagement surface of the second piece of base fabric are set as one-surface sides, setting one of the corner parts of any one of the first piece of base fabric or the second piece of base fabric as an apex and folding back a left-side region or a right-side region in a width direction to observer's right on the one-surface side or observer's left on the one-surface side,
a second folding-back procedure folding back the right-side region or the left-side region in the width direction to the observer's left on the one-surface side or the observer's right on the one-surface side, and
a third folding-back procedure folding back the one-surface side of the second piece of base fabric and the first piece of base fabric using the joint side as a valley folding line such that the hole of the first piece of base fabric and the hole of the second piece of base fabric located at the corner parts not crossing the first piece of base fabric and the second piece of base fabric overlap each other.

7. A method of folding a folding bag using the integrated sheet-like object described in claim 3, comprising the steps of:
a first center-folding procedure matching any one of corner parts of the first piece of base fabric or the second piece of base fabric with the other corner part,
a second center-folding procedure folding back a bottom-side region facing the corner parts of the overlapping first and second pieces of base fabric while leaving an apex-side region including the corner parts,
a fourth folding-back procedure folding back the apex-side region in a strip-shaped body as a whole toward the bottom-side region, and
a connecting procedure overlapping both ends such that the entire strip-shaped body becomes strip-shaped.

8. A method of folding a folding bag using the integrated sheet-like object described in claim 4, comprising the steps of:
a third center-folding procedure, in a state in which a male-side engagement surface or a female-side engagement surface of the first piece of base fabric and a female-side engagement surface or a male-side engagement surface of the second piece of base fabric are set as one-surface sides, setting one corner part crossing the first piece of base fabric and the second piece of base fabric as an apex and folding back a lower half region including the other corner part and an upper half region including one corner part to observer's upper side or observer's lower side,
a fifth folding-back procedure folding back a left-side region or a right-side region in a width direction to a one-surface side or an other-surface side such that an oblique line of the second piece of base fabric or the first piece of base fabric is substantially horizontal and a left-side corner part or a right-side corner part is substantially matched with the oblique line of the first piece of base fabric or the second piece of base fabric, and
a sixth folding-back procedure folding back the right-side region or the left-side region in the width direction to a one-surface side or an other-surface side such that the oblique line of the first piece of base fabric or the second piece of base fabric is substantially horizontal and a right-side corner part or a left-side corner part is substantially matched with the oblique line of the second piece of base fabric or the first piece of base fabric.

9. A method of folding a folding bag using the integrated sheet-like object described in claim 5, comprising the steps of:
a first folding-back procedure, in a state in which a male-side engagement surface or a female-side engagement surface of the first piece of base fabric and a female-side engagement surface or a male-side engagement surface of the second piece of base fabric are set as one-surface sides, setting one of the corner parts of any one of the first piece of base fabric or the second piece of base fabric as an apex and folding back a left-side region or a right-side region in a width direction to observer's right on the one-surface side or observer's left on the one-surface side,
a second folding-back procedure folding back the right-side region or the left-side region in the width direction to the observer's left on the one-surface side or the observer's right on the one-surface side, and
a third folding-back procedure folding back the one-surface side of the second piece of base fabric and the first piece of base fabric using the joint side as a valley folding line such that the hole of the first piece of base fabric and the hole of the second piece of base fabric located at the corner parts not crossing the first piece of base fabric and the second piece of base fabric overlap each other.

10. A method of folding a folding bag using the integrated sheet-like object described in claim 4, comprising the steps of:
a first center-folding procedure matching any one of corner parts of the first piece of base fabric or the second piece of base fabric with the other corner part,
a second center-folding procedure folding back a bottom-side region facing the corner parts of the overlapping first and second pieces of base fabric while leaving an apex-side region including the corner parts,
a fourth folding-back procedure folding back the apex-side region in a strip-shaped body as a whole toward the bottom-side region, and
a connecting procedure overlapping both ends such that the entire strip-shaped body becomes strip-shaped.

11. A method of folding a folding bag using the integrated sheet-like object described in claim 5, comprising the steps of:
a first center-folding procedure matching any one of corner parts of the first piece of base fabric or the second piece of base fabric with the other corner part,
a second center-folding procedure folding back a bottom-side region facing the corner parts of the overlapping first and second pieces of base fabric while leaving an apex-side region including the corner parts,
a fourth folding-back procedure folding back the apex-side region in a strip-shaped body as a whole toward the bottom-side region, and
a connecting procedure overlapping both ends such that the entire strip-shaped body becomes strip-shaped.

12. A method of folding a folding bag using the integrated sheet-like object described in claim 5, comprising the steps of:
a third center-folding procedure, in a state in which a male-side engagement surface or a female-side engagement surface of the first piece of base fabric and a female-side engagement surface or a male-side engagement surface of the second piece of base fabric are set as one-surface sides, setting one corner part crossing the first piece of base fabric and the second piece of base fabric as an apex and folding back a lower half region including the other corner part and an upper half region including one corner part to observer's upper side or observer's lower side,
a fifth folding-back procedure folding back a left-side region or a right-side region in a width direction to a one-surface side or an other-surface side such that an oblique line of the second piece of base fabric or the first piece of base fabric is substantially horizontal and a left-side corner part or a right-side corner part is substantially matched with the oblique line of the first piece of base fabric or the second piece of base fabric, and
a sixth folding-back procedure folding back the right-side region or the left-side region in the width direction to a one-surface side or an other-surface side such that the oblique line of the first piece of base fabric or the second piece of base fabric is substantially horizontal and a right-side corner part or a left-side corner part is substantially matched with the oblique line of the second piece of base fabric or the first piece of base fabric.
